(19) United States
(12) Patent Application Publication
(10) Pub. No.: US 2007/0029137 A1
(43) Pub. Date: Feb. 8, 2007

(54) Collapsible ladder

(76) Inventor: Graham Kenedy Welsh, Laverton (AU)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/216,148

(22) Filed: Sep. 1, 2005

(30) Foreign Application Priority Data
Aug. 2, 2005 (AU) 2005203398

(51) Int. Cl. E06C 9/00

(52) U.S. Cl. 182/96

(57) ABSTRACT

The disclosed invention is a collapsible ladder of simple construction and operation that can remain secure whilst being locked in the collapsed position to prevent unauthorised access. The ladder consist of a plurality of rungs pivotally connected to a pair of parallel rails. The key operated locking mechanism is designed to be tamper proof. The locking mechanism includes a rotatable latch that securely engages an opening in one of the rungs.

### FIELD OF THE INVENTION

The present invention relates broadly to a collapsible ladder.

### BACKGROUND TO THE INVENTION

The traditional domestic or tradesman's ladder is constructed of timber or aluminium alloy. The ladder includes a pair of parallel and spaced apart rails interconnected with a series of rungs. The ladder may be of a single or two-piece construction in which case it is extendable. This type of ladder is portable and being relatively lightweight can be transported by hand to its required site of use. The ladder is by hand raised into its vertical but slightly inclined position and leant against the structure to which access is sought. An operator such as a tradesman can then scale the ladder rung by rung.

The applicant's international patent application no. PCT/AU03/00469 discloses a collapsible ladder including a pair of opposing rails interconnected with a plurality of rungs which are pivotally connected at opposing ends to respective of the rails. The collapsible ladder can thus be collapsed wherein the opposing pair of rails abut one another whereas in an operative position the rails are laterally spaced with the interconnecting rungs being disposed substantially perpendicular to the rails. The collapsible ladder is locked into its collapsed condition by means of a plunger of a locking mechanism which is fixed to one of the rails, the plunger being arranged to engage a locking pin extending from an inside face of the other of the opposing rails. The locking pin is typically welded to the rail and designed to protrude through an opening in both one of the rungs and the opposing rail when the collapsible ladder is in its collapsed condition. Although relatively effective in securing the ladder in its collapsed condition, this arrangement suffers from at least the following problems:

1. The locking mechanism is largely exposed and as such can be tampered with or vandalised so as to release the collapsible ladder from its collapsed condition; and

2. The locking mechanism requires fairly significant modification to the ladder in fixing the locking pin to one of the pair of rails and forming an opening in one of the rungs and the opposing rail.

The patent specification of European patent publication no. 0136904 (by Reitzer) also discloses a collapsible ladder, but in this example relies upon both pivotal and then sliding movement of its parallel rails for reconfiguration into its collapsed orientation. This ladder includes a locking finger, which on pivotal and sliding movement of the rails is aligned with an aperture in a tread of one of the rungs. The locking finger then slidably moves into or out of engagement with the aperture to prevent further sliding movement of the rail relative to the tread rung, so as to retain the ladder in its collapsed orientation. The collapsible ladder and locking finger mechanism are relatively complicated in their fabrication.

### SUMMARY OF THE INVENTION

According to the present invention there is provided a collapsible ladder comprising:
a pair of opposing and substantially parallel rails;
a plurality of rungs being elongate and pivotally connected at or adjacent opposing ends to respective of the pair of rails, the ladder being reconfigurable by pivotal movement only from an operational condition wherein the parallel rails are laterally separated from one another and disposed generally perpendicular to the rungs to permit access to the ladder, to a collapsed condition wherein the rails locate adjacent one another to prevent access to the ladder; and
a locking mechanism mounted to one of the rails and including an actuator connected to a locking member, the actuator being movable to effect movement of the locking member which releasably engages one of the rungs and/or an opposing of the rails to retain the ladder in the collapsed condition.

Preferably the actuator is a rotatable actuator and relies upon rotary movement for a corresponding movement in the locking member.

Preferably the locking member includes a latch or locking cam designed to securely engage an opening in said one of the rungs for retention of the ladder in the collapsed condition. More preferably the opening in said one of the rungs is a slot located adjacent the opposing of the pair of rails. Still more preferably the slot is formed in a tread of said one of the rungs.

Preferably the collapsible ladder also comprises biasing means operatively coupled to one of the rails and at least one of the rungs for urging the ladder into the collapsed condition. More preferably the biasing means includes a torsion spring arranged to engage both said one of the rails and the rung.

Preferably the collapsible ladder at and adjacent its upper end is free of the ladder rungs for a height substantially greater than shoulder height of a person and providing unobstructed access between the pair of rails.

Preferably the collapsible ladder further comprises anchoring means connected to one or both of the pair of rails and being adapted to permanently or temporarily mount the ladder to a structure. More preferably the anchoring means includes a bracket connected at a lower end of one of the rails and adapted to fix a lower part of the structure, and a locating member connected adjacent an upper end of one of the rails and adapted to anchor to an elevated part of the structure. Even more preferably the bracket is pivotally coupled to the rail to permit variations in the pitch of the ladder, and the locating member includes a locating pin being adapted to removably locate in a corresponding recess in the structure. Still more preferably the locating member is in the form of another bracket which is detachably secured to respective of the rails at a selected one of a series of different vertical positions.

Preferably the pivotal connection between the rungs and the rails is provided by a pivot pin coupled to the rail and each of the rungs.

Preferably the pair of rails are each fabricated of channel-section members having their respective flanges aligned with and directed toward one another, the rungs being configured to nest within the channel-section rails with the ladder in the collapsed condition. More preferably the rungs are also fabricated of channel-section members having a width dimension across opposing flanges of less than the corresponding internal width dimension of the rails.

Preferably the collapsible ladder is fabricated or extruded from an aluminium alloy.

### BRIEF DESCRIPTION OF THE FIGURES

In order to achieve a better understanding of the nature of the present invention, a preferred embodiment of a collapsible ladder will now be described, by way of example only, with reference to the accompanying drawings in which:

FIGS. 1 and 2 are schematic illustrations of a collapsible ladder in its collapsed and semi-operational conditions, respectively;

FIG. 3 is a perspective view of the collapsible ladder of FIGS. 1 and 2 in the operational condition erected adjacent a structure;

FIG. 4 is a front elevational view of the collapsible ladder in its collapsed condition;

FIGS. 5 and 6 are front and side elevational views, respectively, of the collapsible ladder in its operational condition;

FIGS. 7a and 7b are detailed views of detail 7 of FIG. 5 of the collapsible ladder together with the locking mechanism in the collapsed, semi-operational and operational conditions;

FIG. 8 is a side sectional view of part of the collapsible ladder of FIG. 2;

FIG. 9 is a sectional view taken through 9-9 of FIG. 8;

FIG. 10 is a detailed view of detail 10 of FIG. 8;

FIG. 11 is a schematic illustration of the collapsible ladder of the preceding figures shown at various pitches or inclinations.

FIG. 12 is a cross-sectional view of one of the pair of opposing rails of the collapsible ladder of the preceding figures;

FIG. 13 is a cross-sectional view of one of the plurality of rungs of the collapsible ladder of the preceding figures;

FIG. 14 are cross-sectional views of the locking mechanism of FIGS. 7a and 7b; and

FIG. 15 are further detailed views of part of the collapsible ladder of the preceding figures.

### DETAILED DESCRIPTION OF THE PREFERRED EMBODIMENT

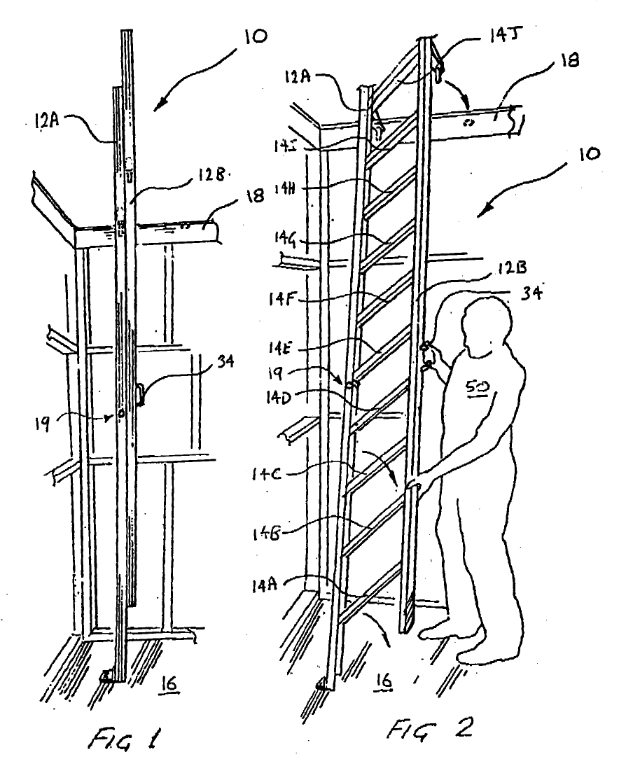

As best shown in FIGS. 1 to 3 there is a collapsible ladder 10 comprising a pair of opposing rails 12A and 12B interconnected with a plurality of rungs 14A to 14J. The collapsible ladder 10 can in this embodiment be moved or manipulated from a collapsed condition to an operational condition as shown in FIGS. 1 and 3, respectively.

In the collapsed condition of FIG. 1 the opposing pair of rails 12A/B located adjacent or abut one another, whereas in the operational position of FIG. 3 the rails 12A/B are laterally spaced with the interconnecting rungs 14A to 14J being disposed substantially perpendicular thereto. In this embodiment the collapsible ladder 10 is erected in a stairwell (not designated) of a building structure providing access between a lower floor 16 and upper floor 18. One of the rails 12A is fixed at its lower end to the floor 16 and anchored adjacent an opposite end to the upper floor 18, whilst the other rail 12B is allowed to move or float relative and parallel to the fixed rail 12A. The collapsible ladder 10 is thus manipulated from the collapsed to the operational conditions.

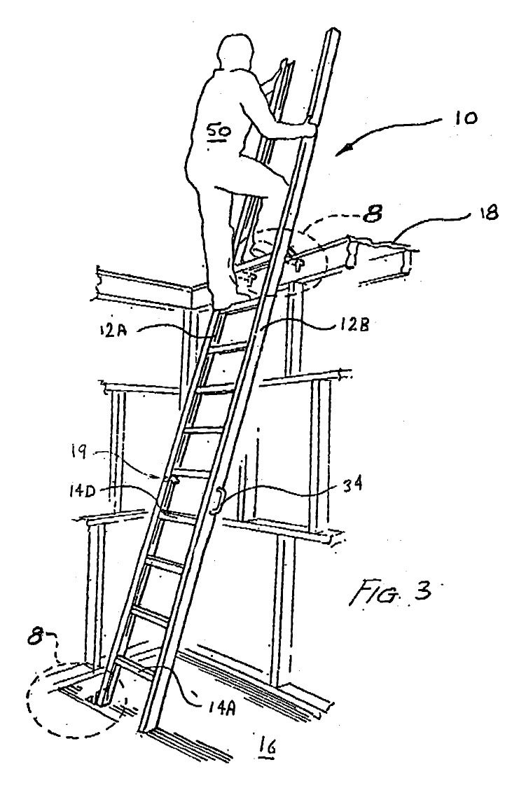

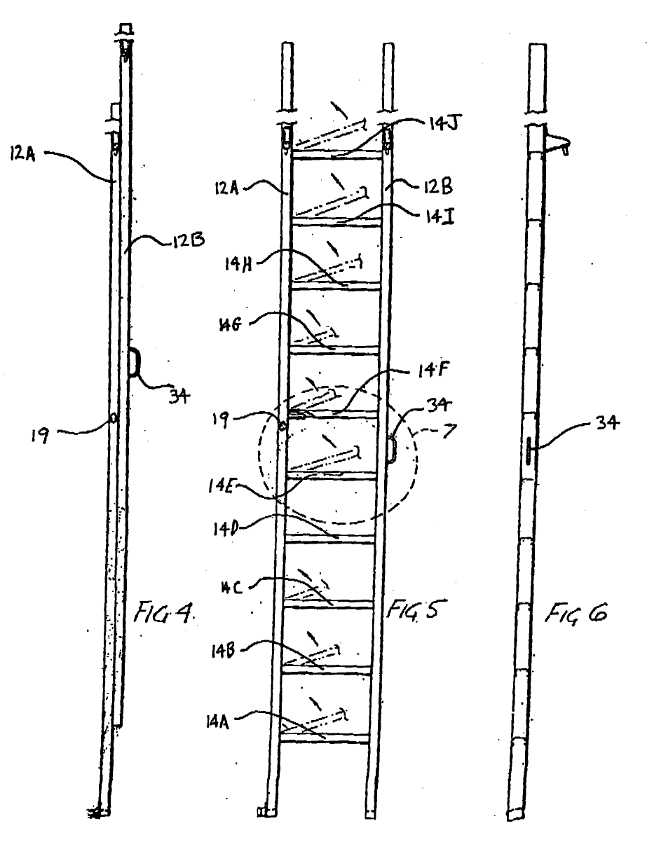

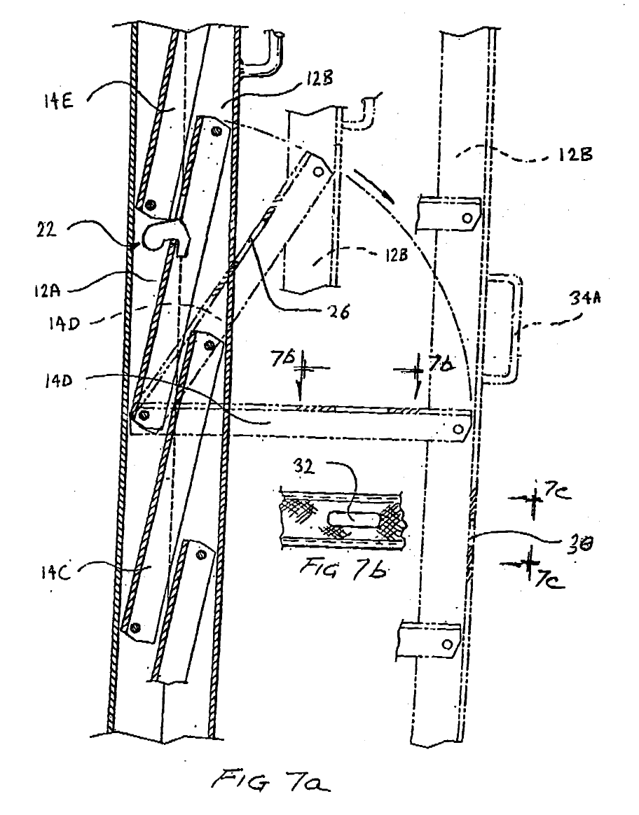

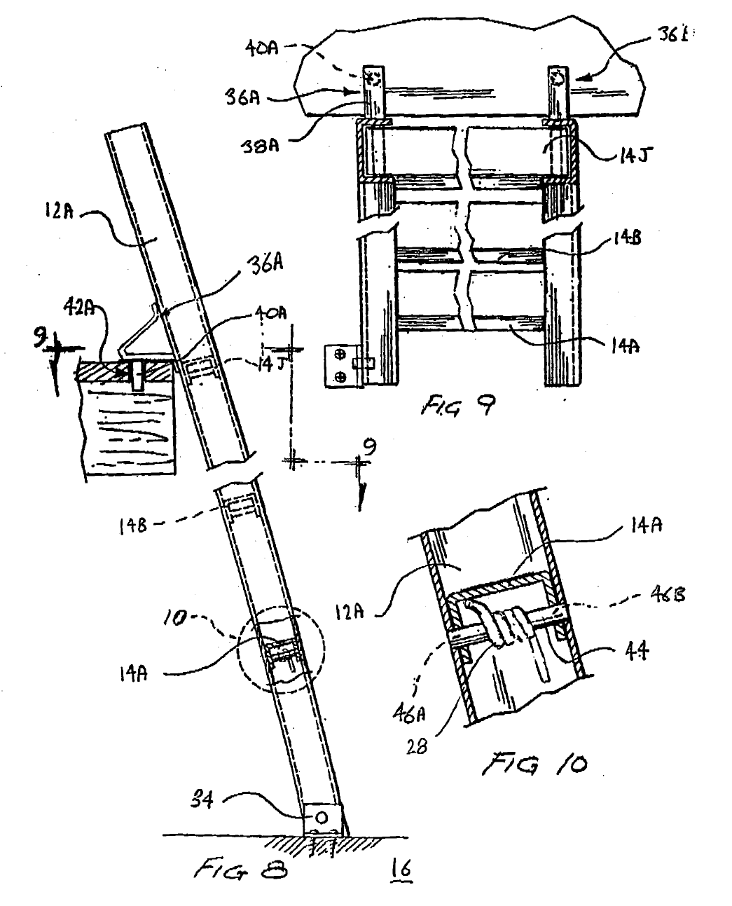

As best shown in FIGS. 7a and 7b each of the rungs such as 14C to 14E, is at its opposing ends pivotally connected to respective of the opposing pair of rails 12A and 12B. This pivotal connection between the rungs, such as 14D and rails 12A/B, allows the ladder 10 to move from its operational to collapsed conditions with racking of the rungs 14A to 14J. In the collapsed condition, the rungs 14A to 14J are nested or housed within the opposing pair of abutting rails 12A/B. The collapsible ladder also comprises a locking mechanism 19 (see FIGS. 2 and 3), including an actuator 20 connected to a locking member 22. The actuator 20 is in this embodiment a shaft or rotatable actuator which is key operated. The rotatable actuator 20 is keyed or otherwise fixed to the locking member 22, which in this embodiment is in the form of a locking cam. The locking cam 22 is designed to securely engage an opening 26 or in this example, a slot formed in a tread of one of the rungs such as 14D, when the collapsible ladder 10 is in its collapsed condition. In order to effectively secure the collapsed ladder in this collapsed condition, the slot 26 is located adjacent the rail 12A opposite the locking mechanism. This increases the force required to dislodge the collapsible ladder 10 from its collapsed condition. The opening or slot 26 is shaped in the form of a keyway to allow the rotational passage of the locking cam 22 in the collapsed condition.

As also shown in FIG. 10, the collapsible ladder 10 comprises biasing means in the form of a torsion spring 28 operatively coupled to one of the rails 12A and in this example the lowermost of the rungs 14A. The torsion spring 28 is spiral wound from relatively heavy gauge steel and is in a relaxed condition with the collapsible ladder 10 in its collapsed condition. The torsion spring 28 is tensioned on movement of the collapsible ladder from the collapsed into the operational conditions. Therefore, the torsion spring 28 assists in urging the lowermost rung 14A together with the rail 12B and its associated other rungs 14B to 14J toward the collapsed conditions. The collapsible ladder 10 also includes a handle 34 used for manipulation of the ladder 10 between its collapsed and operational conditions. The handle 34 is fixed to the floating rail 12B and positioned to allow together with the assistance of the torsion spring 28 relatively easy movement of the floating rail 12B between the collapsed and operational positions. The handle 34 also provides relatively even weighting of the ladder 10 for carrying it in its collapsed condition.

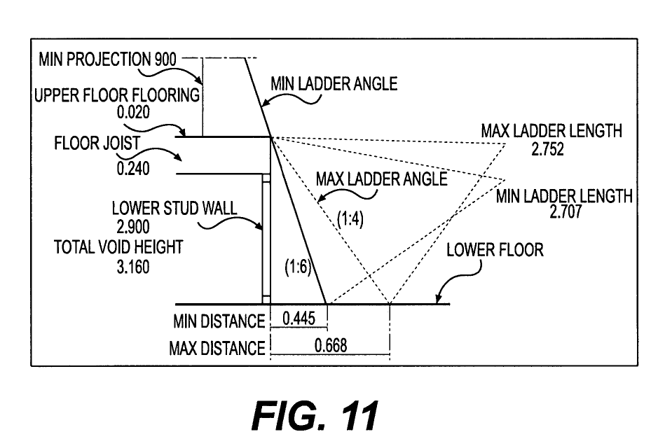

As best shown in FIGS. 8 and 9, the collapsible ladder 10 includes anchoring means for securement of the ladder 10. In this embodiment the anchoring means includes a bracket 35 and a pair of locating members 36A and 36B. The bracket 35 is pivotally connected to a lower end of the fixed rail 12A and fastened to the lower floor 16. The pair of locating members 36A/B each include another bracket such as 38A detachably secured to a rear face of the rail 12A, and a locating pin or dowel such as 40A mounted underneath and protruding downwardly off the bracket 38A. The dowel 40A is designed to removably locate within a corresponding recess 42A formed in the upper floor 18. The other brackets 36A/B on engagement with their respective recesses, such as 42A effectively mount or support the collapsible ladder 10 both in its collapsed and operational conditions adjacent the building structure. The pivot bracket 34 and locating members 36A/B of this particular embodiment permit variations in the pitch or inclination of the ladder 10. FIG. 11 schematically illustrates variations in the pitch or inclination of the ladder such as 10 for this particular application.

FIG. 10 most clearly illustrates the preferred pivotal connection of the rungs such as 14A to the opposing rails 12A/B. The pivotal connection is provided by a pivot pin such as 44, which at opposing ends is swaged or otherwise fixed to respective opposing flanges of this example the fixed rail 12A. The rung 14A has a pair of clearance holes such as 46A and 46B in its respective opposing flanges and the pivot pin 44 passes through these clearance holes 46A/B to provide the pivotal connection. The ladder rungs such as 14A to G of FIGS. 9 and 10 also includes a corrugated or ribbed surface of a non-skid nature included in the tread of each of the rungs such as 14A.

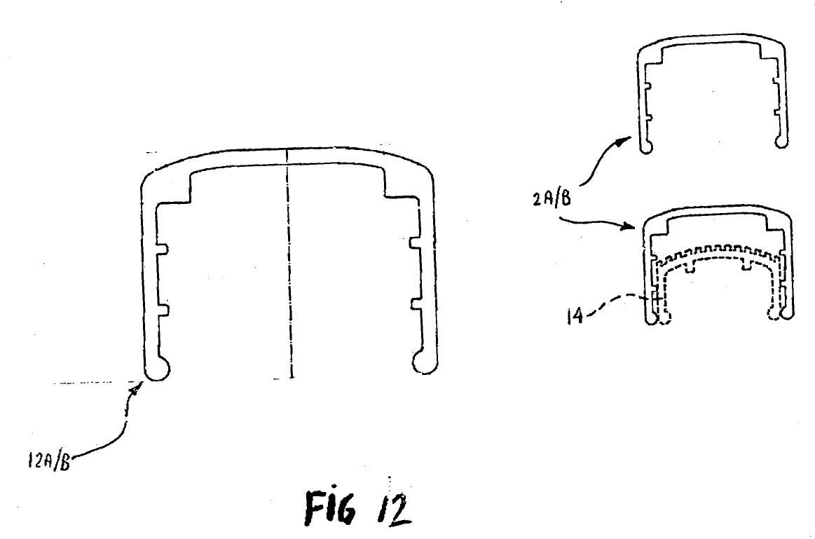

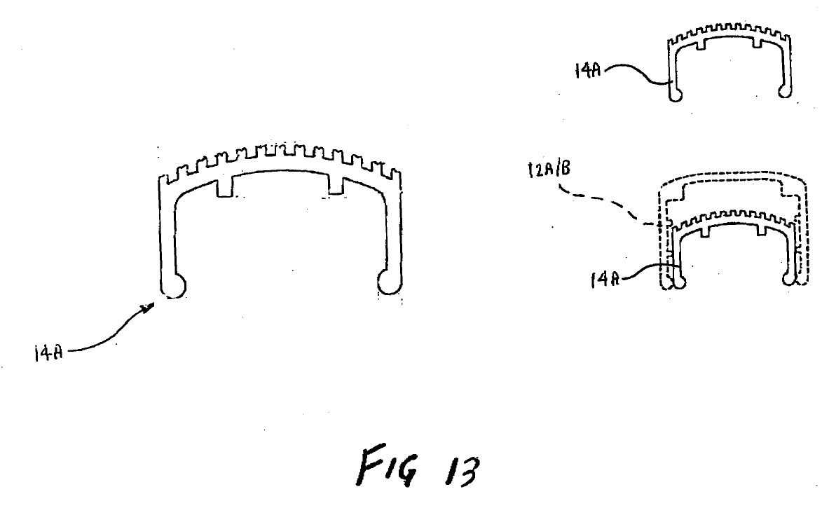

As shown in FIGS. 12 and 13, the rails 12A/B and rungs 14A to 14J of this embodiment are extruded aluminium channel-section members. The rails 12A/B are arranged so that their respective flanges are aligned with and directed toward one another. The rungs such as 14A have a width dimension across opposing flanges of slightly less than the corresponding internal width dimension of the rails 12A/B. The rungs 14A to 14J thus pivot and nest within the opposing pair of rails 12A/B. The web of the channel-section rungs 14A to 14J faces upward and forms the tread for each of the rungs such as 14A. The channel-section rails 12A/B and rungs 14A to 14J are extruded from an aluminium alloy and may also be anodised, powder or otherwise coated.

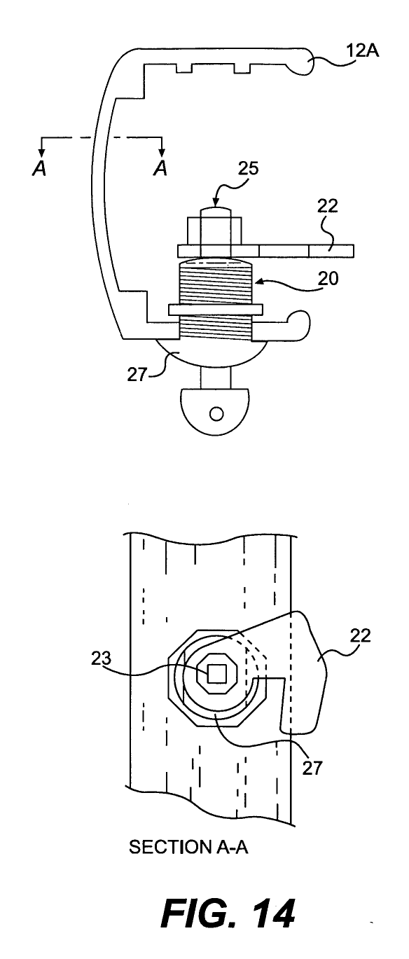

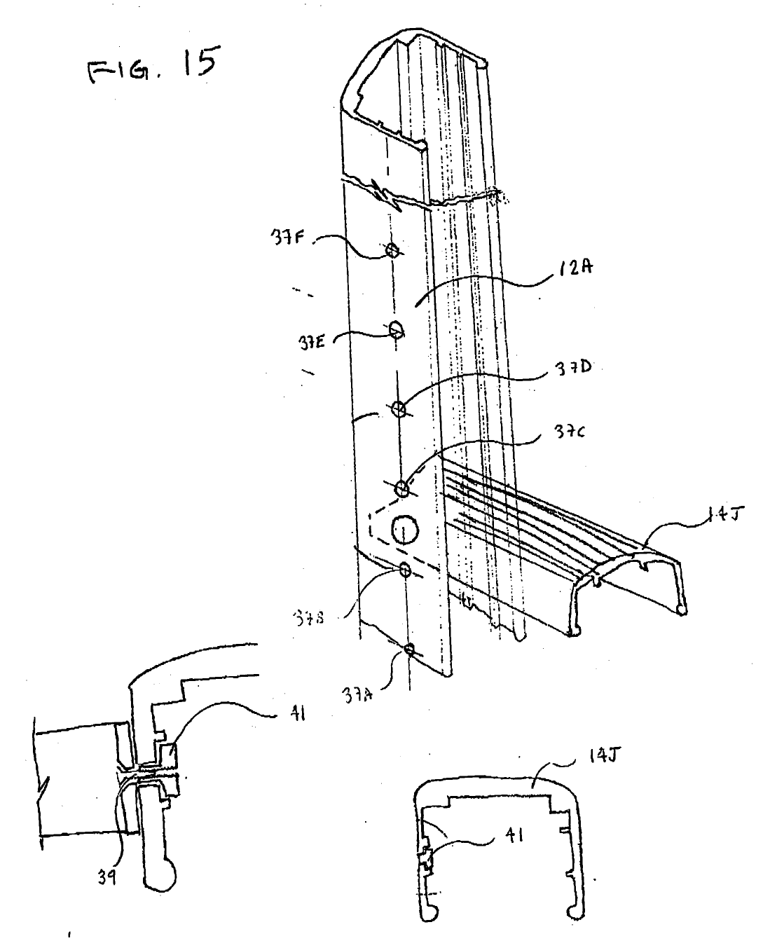

The locking mechanism 19 is shown in detail in FIG. 14. The locking cam 22 may be shaped in accordance with the lowermost representation and acts as a latch to releasably engage or hook the slot 26 in the rail 14D. The locking cam 22 includes a recess or aperture 23 which is engaged by the actuator 20 in the form of a shaft 25 which effects rotation of the locking cam 22. The shaft 25 is connected to and actuated by a key-operated mechanism 27 which is mounted to the fixed rail 12A.

FIG. 15 illustrates fastening of one of the upper brackets 36A to the corresponding rail 12A which includes a series of fastening holes 37A to 37F formed in and longitudinally spaced along the rail 12A. The upper brackets such as 36A can be fastened to the rail 12 using the countersunk screw 39 and clinch nut 41 at a selected position along the rail 12 depending on the application.

In order to further assist and understand the invention, operation of this embodiment of the collapsible ladder 10 will now be described in terms of the following general steps:

1. The collapsible ladder 10 is carried by the handle 34 in its collapsed condition to the site at which it will be erected;

2. The collapsible ladder 10 is screw fastened to the lower floor 16 using the bracket 35 of the fixed rail 12A, and the locating member or upper bracket 36A of the fixed rail 12A is positioned in a pre-drilled hole 42A of the upper floor 18;

3. The key-operated mechanism 27 is unlocked and the locking member or cam 22 pivoted from engagement with the slot or keyway 26 in the rung to permit movement of the floating rail 12B away from the fixed rail 12A as depicted in FIG. 2; and

4. The collapsible ladder 10 is moved into the operational condition, wherein a lower end of the floating rail 12B abuts the lower floor 16 and the other locating member or upper bracket 36B adjacent the upper end of the floating rail 12B locates within the other pre-drilled hole in the upper floor 18.

In the operational condition the collapsible ladder 10 provides access for a person such as 50 to scale the ladder 10 via the rungs 14A to 14J in a conventional manner. The ladder 10 at an adjacent its upper end is free of ladder rungs and thus provides unobstructed access between the pair of rails 12A/B.

In order to move the ladder from its operational to collapsed conditions, the procedure outlined above involving steps 1 to 4 is essentially performed in reverse. The floating rail 12B is swung via the handle 34 upwardly and toward the fixed rail 12A. The ladder 10 in its collapsed condition with the rails 12A/B abutting one another houses the interconnecting rungs 14A to 14J which are held in this collapsed condition by engagement of the latching member with the keyway 26 of the corresponding rung. In this collapsed condition access to the ladder which remains in-situ is prevented.

It should be appreciated that the collapsible ladder may be installed temporarily as described or may form a permanent fixture on for example tanks, vats, freight carriages and other locations when access to dangerous or secure areas is restricted. The ladder may also be incorporated in scaffolding to prevent access by unauthorised persons, such as children, when the scaffolding is not in use.

Now that a preferred embodiment of the present invention has been described in some detail it will be apparent to those skilled in the art that the collapsible ladder of this embodiment has at least the following advantages:

1. The collapsible ladder is relatively simple in its construction and operation;

2. The collapsible ladder can remain in-situ whilst being locked in the collapsed condition to prevent unauthorised access;

3. The collapsible ladder can be adapted for use in a range of applications for both permanent and temporary locations; and

4. The collapsible ladder including the locking mechanism is designed to be tamper proof.

Those skilled in the art will appreciate that the invention described herein is susceptible to variations and modifications other than those specifically described. For example, the various components of the collapsible ladder are not limited to those described, but may for example extend to members of different geometry and materials of construction. All such variations and modifications are to be considered within the scope of the present invention, the nature of which is to be determined from the foregoing description.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

1. A collapsible ladder comprising:
a pair of opposing and substantially parallel rails;
a plurality of rungs being elongate and pivotally connected at or adjacent opposing ends to respective of the pair of rails, the ladder being reconfigurable by pivotal movement only from an operational condition wherein the parallel rails are laterally separated from one another and disposed generally perpendicular to the rungs to permit access to the ladder, to a collapsed condition wherein the rails locate adjacent one another to prevent access to the ladder; and
a locking mechanism mounted to one of the rails and including an actuator connected to a locking member, the actuator being movable to effect movement of the locking member which releasably engages one of the rungs and/or an opposing of the rails to retain the ladder in the collapsed condition.

2. A collapsible ladder as defined in claim 1 wherein the actuator is a rotatable actuator and relies upon rotary movement for a corresponding movement in the locking member.

3. A collapsible ladder as defined in claim 2 wherein the locking member includes a latch or locking cam designed to securely engage an opening in said one of the rungs for retention of the ladder in the collapsed condition.

4. A collapsible ladder as defined in claim 3 wherein the opening in said one of the rungs is a slot located adjacent the opposing of the pair of rails.

5. A collapsible ladder as defined in claim 4 wherein the slot is formed in a tread of said one of the rungs.

6. A collapsible ladder as defined in claim 1 also comprising biasing means operatively coupled to one of the rails and at least one of the rungs for urging the ladder into the collapsed condition.

7. A collapsible ladder as defined in claim 6 wherein the biasing means includes a torsion spring arranged to engage both said one of the rails and the rung.

8. A collapsible ladder as defined in claim 1 wherein the collapsible ladder at and adjacent its upper end is free of the ladder rungs for height substantially greater than shoulder height of a person and providing unobstructed access between the pair of rails.

9. A collapsible ladder as defined in claim 1 wherein the collapsible ladder further comprising anchoring means connected to one or both of the pair of rails and being adapted to permanently or temporarily mount the ladder to a structure.

10. A collapsible ladder as defined in claim 9 wherein the anchoring means includes a lower bracket connected at a lower end of one of the rails and adapted to fix a lower part of the structure, and a locating member connected adjacent an upper end of one of the rails and adapted to anchor to an elevated part of the structure.

11. A collapsible ladder as defined in claim 10 wherein the locating member includes another bracket which is detachably secured to respective of the rails at a selected one of a series of different vertical positions.

12. A collapsible ladder as defined in claim 10 wherein the lower bracket is pivotally coupled to the rail to permit variations in the pitch of the ladder, and the locating member includes a locating pin being adapted to removably locate in a corresponding recess in the structure.

13. A collapsible ladder as defined in claim 1 wherein the pivotal connection between the rungs and the rails is provided by a pivot pin coupled to the rail and each of the rungs.

14. A collapsible ladder as defined in claim 1 wherein the pair of rails are each fabricated of channel-section members having their respective flanges aligned with and directed toward one another, the rungs being configured to nest within the channel-section rails with the ladder in the collapsed condition.

15. A collapsible ladder as defined in claim 14 wherein the rungs are also fabricated of channel-section members having a width dimension across opposing flanges of less than the corresponding internal width dimension of the rails.

16. A collapsible ladder as defined in claim 1 wherein the collapsible ladder is fabricated from an aluminium alloy.
